(19) United States
(12) Patent Application Publication
(10) Pub. No.: US 2025/0369252 A1
(43) Pub. Date: Dec. 4, 2025

(54) UNIVERSAL DOOR SLAB FOR CYLINDRICAL LOCK APPLICATIONS

(71) Applicant: DURASERV LLC, Carrollton, TX (US)

(72) Inventor: Eddie Johnston, Dalton, OH (US)

(73) Assignee: DURASERV LLC, Carrollton, TX (US)

(21) Appl. No.: 18/733,538

(22) Filed: Jun. 4, 2024

(51) Int. Cl. E05B 15/02

(52) U.S. Cl. CPC E05B 15/021

(57) ABSTRACT

A door assembly comprises a door panel with a plurality of lock bolt holes extending through an edge of the door panel; a lock plate with a plurality of lock plate holes, wherein the lock plate is coupled to the edge of the panel and each of the plurality of lock plate holes is aligned with a respective lock bolt hole of the plurality of lock bolt holes; and a removable trim plate coupled to the lock plate and disposed over the plurality of lock plate holes.

### TECHNICAL FIELD

The present disclosure relates to a universal door slab compatible with multiple lock or door frame configurations.

### BACKGROUND

A man-door is a standard swing door. A man-door may also be referred to as a pedestrian door, a pass door, an access door, or historically a wicket. These doors are just large enough that a single person may enter through the opening. Historically, these doors were used to control access. Rather than open larger gates or doors, the use of the man-door allowed entry of only one person at a time. The man-door provides a convenient way to enter a building or structure without having to open a larger gate or overhead door. Use of a man-door provides several benefits, including preserving privacy and conserving energy compared to larger doors or gates. A man-door also provides an emergency exit in case power to an automated door is not accessible.

Plastics such as polyethylene and polyurethane are a popular material choice for doors. Plastics are easy to clean, easy to maintain, impact resistant, corrosion resistant, eco-friendly, and water-resistant.

Polyethylene has a lower specific gravity than steel, resulting in a lighter product, which makes transportation and installation easier. Despite polyethylene's low specific gravity, polyethylene still has comparable strength and durability to steel. Further, as polyethylene processes developed, plastic became a more cost-effective option than steel, and polyethylene can be easily recycled. Additionally, polyethylene can be used as a resin that may be blended with additives. These additives can increase the strength and durability of polyethylene.

Fiberglass is another popular material choice. Fiberglass is more rigid and lighter than polyethylene. Unlike fiberglass and steel, polyethylene sheets do not have seams or weld points. Further, fiberglass has many advantages similar to polyethylene that are important in construction of materials such as being easy to clean, easy to maintain, and water-resistant. As a result, fiberglass is a popular additive for thermoset resins resulting in fiberglass reinforced plastics or FRPs. FRPs consist of a plastic material reinforced with glass fibers, and are frequently referred to as simply fiberglass in the commercial setting. The addition of FRPs and fiberglass can increase plastic thermal flexibility, strength, durability, and temperature sensitivity. However, FRPs are extremely difficult to recycle due to their composition. Although fiberglass by itself can be recycled by grinding, it is generally difficult to break down the fibers, and the problem is exacerbated when plastic and fiberglass are mixed together. Thermoset resins make the process even more difficult because they do not melt at high temperatures. Although there are methods to recycle FRPs, none are particularly cost-effective. Recycling polyethylene by itself, is a much more cost-effective process.

Polyurethane has unique stretching properties and can be stiff or flexible. Polyurethane is also preferred for applications that require heat resistance or capability to withstand harsh conditions.

Because man-doors are used to control access, it is often desirable for the man-doors to lock to or otherwise engage with a corresponding door frame. In some applications, a replacement door can be installed in a pre-existing door frame or a door frame otherwise configured for use with a door from a major manufacturer (e.g., CECO, Curries, Steel Craft, and Pioneer). In some applications, manufacturers can offer door frames with frame bolt holes at heights standard to that manufacturer. For example, CECO offers a door frame configured for use with a cylindrical lock approximately 41 inches from the bottom of the door. In another example, Curries and Steel and Craft both offer a door frame configured for use with a cylindrical lock approximately 39 inches from the bottom of the door. Further, Pioneer offers a door frame configured for use with a cylindrical lock approximately 37 inches from the bottom of the door.

Many of these doors are installed in commercial/industrial settings that operate 24 hours a day and result in significant wear and tear on the door. In some applications, by the time a door needs to be replaced, the door and door frame manufacturer may not be easily identified. This can be problematic when selecting a new door to fit within an existing door frame. Further, some businesses may use multiple manufacturers for various doors and door frames throughout their business. The use of multiple types of door frames may require different door replacements depending on the manufacturer of the door frame. Replacing doors for multiple types of door frames can be burdensome, as the manufacturer (or the lock height) of each door frame must be identified before obtaining the replacement doors, instead of simply counting the number of doors that need to be replaced.

Further, on-site drilling or configuration of a new door, such as a polyethylene or polyurethane door, can be difficult. The process can be messy, jeopardize the integrity of the door, and locating and drilling the lock bolt hole may be susceptible to human error. The process can also be time consuming, which may result in extended downtime for the install location and/or business, potentially resulting in significant loss in productivity and revenue.

Therefore, what is desired is a universal door that can work for multiple door frame or lock configuration applications, and which is affordable, durable, and strong.

### SUMMARY

In one embodiment, the invention may comprise a door panel comprising a plurality of lock bolt holes extending through an edge of the door panel; a lock plate comprising a plurality of lock plate holes, wherein the lock plate is coupled to the edge of the panel and each of the plurality of lock plate holes is aligned with a respective lock bolt hole of the plurality of lock bolt holes; and a removable trim plate coupled to the lock plate and disposed over the plurality of lock plate holes.

In another embodiment, the invention may comprise a polyethylene plastic door assembly comprising a polyethylene door body comprising a first polyethylene plastic door body comprising a first plurality of cut-outs on an inner face of the first polyethylene plastic door body; a second polyethylene plastic door body comprising a second plurality cut-outs on an inner face of the second polyethylene plastic door body, wherein the second plurality of cut-outs mirror the first plurality of cut-outs, and wherein the inner face of the first polyethylene plastic door body and inner face of the second polyethylene plastic door body are coupled to form the polyethylene door body; a plurality of lock bolt holes extending through an edge of the polyethylene door body; and a lock plate comprising a plurality of lock plate holes, wherein the lock plate is coupled to the edge of the panel and each of the plurality of lock plate holes is aligned with a respective lock bolt hole of the plurality of lock bolt holes.

Embodiments of the invention described herein may utilize a method to install a door comprising positioning a door panel in a door frame, the door panel comprising a plurality of lock bolt holes extending through an edge of the door panel; identifying a lock bolt hole configuration of the plurality of lock bolt holes corresponding to a mating frame bolt hole configuration of the door frame; covering at least one lock bolt hole of the plurality of lock bolt holes via a trim plate to provide the lock bolt hole configuration corresponding to the mating frame bolt hole configuration of the door frame; and attaching the door panel to the door frame.

### BRIEF DESCRIPTION OF DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is cross sectional view of a door with universal lock applications.

FIG. 2 is an enlarged view of the lock bolt holes.

FIG. 3 is a perspective view of an embodiment of a door with universal lock applications.

FIG. 4 is an enlarged view of an example lock configuration.

FIG. 5 is a perspective view of an embodiment of a lock plate.

FIG. 6 is a perspective view of an embodiment of a trim plate.

FIG. 7 is a perspective view of an embodiment of a separate trim plate.

FIG. 8A is a perspective view of a door panel within a door frame.

FIG. 8B is a perspective view of installing a lock plate on a door panel within a door frame.

FIG. 8C is a perspective view of a door panel with an installed lock assembly.

### DETAILED DESCRIPTION

The present disclosure relates generally to a door, and more particularly, to a universal door slab for cylindrical lock applications. As described herein, embodiments of the universal door slab improve upon conventional door slabs.

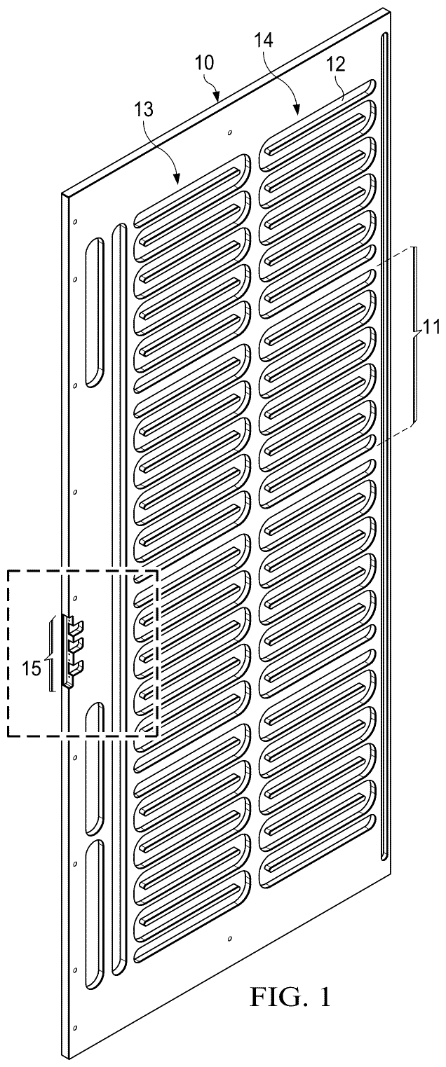

FIG. 1 shows an embodiment of a door body 10 with universal lock holes. In some embodiments, the door body 10 is made up of high-density polyethylene and polymer blend additives and is approximately 35¾ inches by 83⅛ inches, which is compatible with a 3 foot by 7-foot door. In other embodiments the door body may be approximately 47¾ inches by 83⅛ inches, 35¾ inches by 95⅛ inches, 47¾ inches by 95⅛ inches or 41¾ inches by 83⅛ inches. As illustrated, a horizontal pattern 12 can be formed on an inner face of the door body 10. In some embodiments, the horizontal pattern 12 is arranged by a series of horizontal cut-outs 11 made across the surface of the inner face of the door body 10. Further, the door body 10 can include two columns, 13 and 14, each with a plurality of horizontal cut-outs 11. In some applications, the plastic removed from door body 10 when horizontal cut-outs 11 are formed is sent back into the supply chain, thus resulting in a zero-waste production. Further, embodiments of the door body 10 and methods of manufacturing the door body 10 are described in U.S. Pat. No. 11,572,736, entitled “Recyclable plastic man-door”, issued Feb. 7, 2023 and incorporated by reference here.

In some embodiments, the door body 10 includes a plurality of lock bolt holes 15 to allow the door body 10 to receive a lock assembly while being compatible with multiple lock and/or door frame configurations. As illustrated in FIG. 1, the lock bolt holes 15 are cut out from the edge of the door body 10. In some embodiments, there are at least three lock bolt holes 15 cut from the edge of the door body 10.

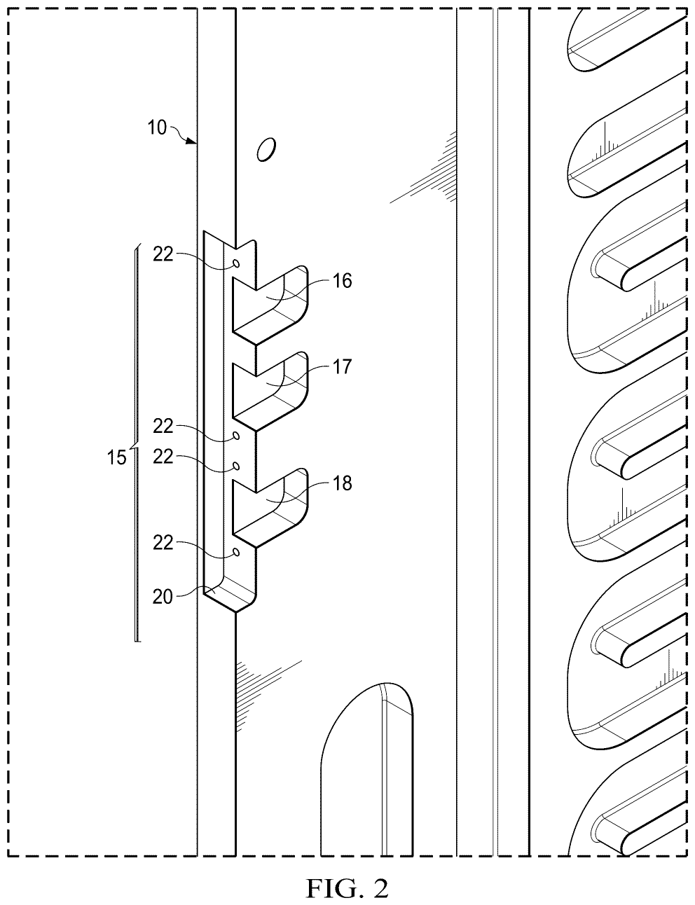

FIG. 2 shows an enlarged view of the lock bolt holes 15 depicted in FIG. 1. As illustrated, each of the plurality of lock bolt holes 15 is sized or otherwise configured to receive a compatible lock assembly. During installation, a lock assembly can be installed in one of the lock bolt holes 15 to allow a door panel 100 to engage or lock with a corresponding door frame. In certain embodiments, the plurality of lock bolt holes 15 are each 1 inch in diameter. In some embodiments, the lock bolt holes 15 are rectangular holes on the edge of the door body 10. In some embodiments, the lock bolt holes 15 are square holes on the edge of the door body 10. The lock bolt holes 15 extend into the door approximately 1 9/16 inches and have a curved shape within the door body 10. This results in a lock bolt hole 15 with a rectangular shape with one flat side adjacent to the edge of the door body 10 and one curved side within the door body 10.

For example, in the illustrated embodiment there are at least three lock bolt holes 15 cut from the edge of the door body 10. In this embodiment, the first lock bolt hole 16 is positioned or otherwise configured to allow a lock assembly installed therein to engage with a mating frame bolt hole of a CECO (or equivalent) manufactured door frame, allowing the door body 10 to be compatible with the CECO (or equivalent) door frame. For example, the center of the lock bolt hole 16 can be approximately 41 1/16 inches from the bottom of the door body 10, corresponding to the positioning of the frame bolt hole of the CECO door frame.

In this embodiment, the second lock bolt hole 17 is positioned or otherwise configured to allow a lock assembly installed therein to engage with a mating frame bolt hole of a Curries or Steel Kraft (or equivalent) manufactured door frame, allowing the door body 10 to be compatible with a Curries or Steel Kraft (or equivalent) door frame. For example, the center of lock bolt hole 17 can be approximately 39 7/16 inches from the bottom of the door body 10, corresponding to the positioning of the frame bolt hole of a Curries or Steel Kraft door frame.

In this embodiment, the third lock bolt hole 18 is positioned or otherwise configured to allow a lock assembly installed therein to engage with a mating frame bolt hole of a Pioneer (or equivalent) manufactured door frame, allowing the door body 10 to be compatible with the Pioneer (or equivalent) door frame. For example, the center of lock bolt hole 18 can be approximately 37¼ inches from the bottom of the door body 10, corresponding to the positioning of the frame bolt hole of the Pioneer door frame.

Advantageously, by positioning the lock assembly in one of the lock bolt holes 16, 17, 18, the lock assembly can be aligned with the mating frame bolt hole of the pre-existing or otherwise desired door frame, permitting the door panel 100 to be used with a wide variety of door frames. Further, by predrilling or precutting the plurality of lock bolt holes 15 in the door body 10 during manufacturing, the lock bolt holes 15 can be more precisely, accurately, and/or repeatably aligned with the corresponding door frames, permitting the door panel 100 to be installed on-site in an easier and faster process.

In certain embodiments, the plurality of lock bolt holes 15 are disposed within a generally rectangular recess 20 within the edge of the door body 10. As illustrated herein, recess 20 is configured to receive a lock plate 24 to reinforce the plurality of lock bolt holes 15, while allowing the lock plate 24 to be flush to the edge of the door body 10. In certain embodiments, a plurality of screw holes 22 are positioned within recess 20 between the plurality of lock bolt holes 15. In certain embodiments, the screw holes 22 are ⅛″ in diameter and 1″ deep. The screw holes 22 enable the lock plate 24 to be mounted to the edge of the door body 10.

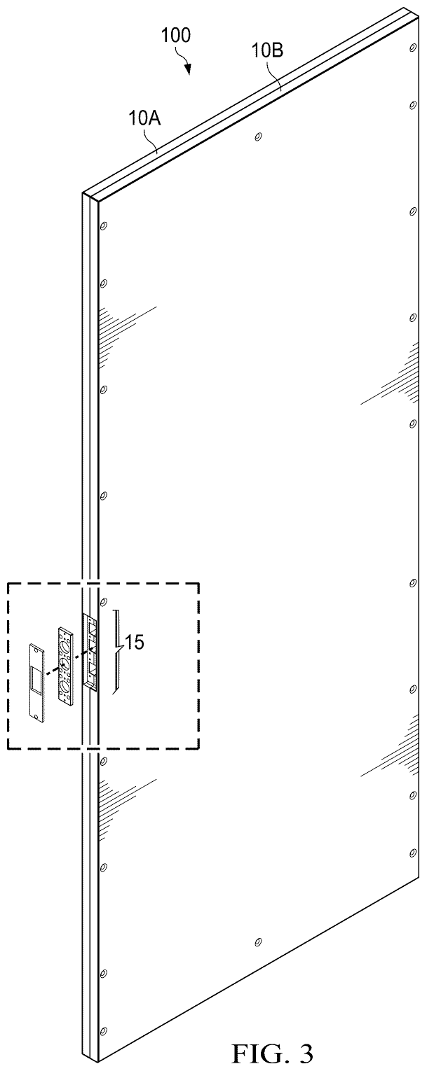

FIG. 3 shows an exemplary embodiment of a door panel 100. The door panel 100 is formed by coupling the inner face of a first door body 10A and the inner face of a second door body 10B. The first door body 10A and second door body 10B may be positioned so that the horizontal patterns 12 on the inner face of the first door body 10A mirror the horizontal patterns 12 on the inner face of the second door body 10B. Further, the lock bolt holes 15 formed on either side of the door body 10A, 10B are mated together to define the lock bolt holes 15 in the edge of the door panel 100.

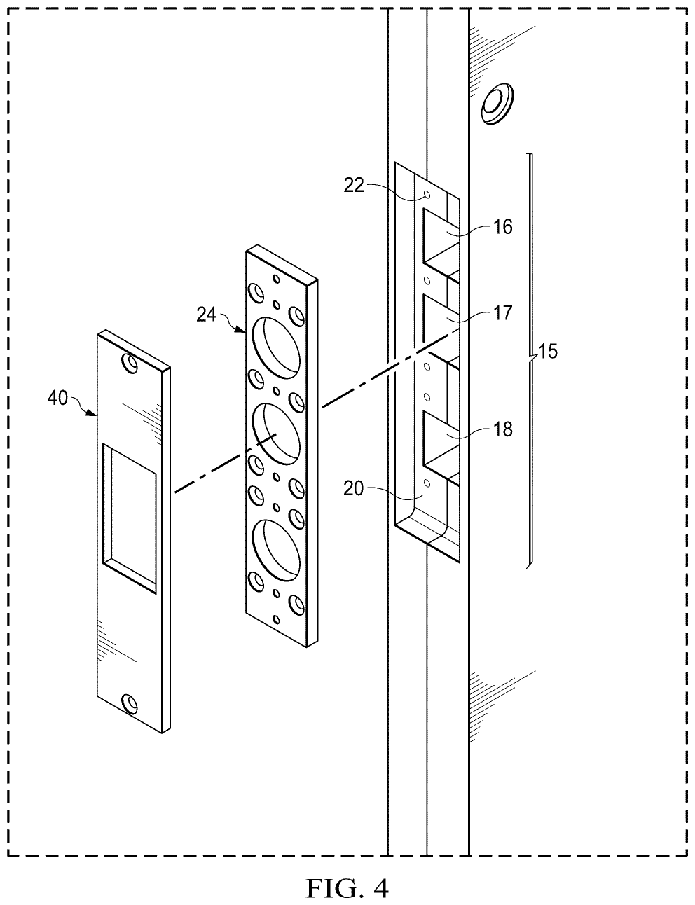

FIG. 4 shows an enlarged view of the lock bolt holes 15 depicted in FIG. 3. As discussed with reference to FIG. 2, the door panel 100 includes a first lock bolt hole 16, a second lock bolt hole 17, and a third lock bolt hole 18 disposed within recess 20. Recess 20 is configured to receive a lock plate 24 to reinforce the plurality of lock bolt holes 15. In some embodiments, a trim plate 40 can be disposed over the lock plate 24 to cover some or all of the lock plate 24 as well as some or all of the lock bolt holes 15. As described herein, recess 20 can be configured to permit the trim plate 40 to be disposed flush to the edge of the door panel 100 when installed over the lock plate 24 and the lock bolt holes 15.

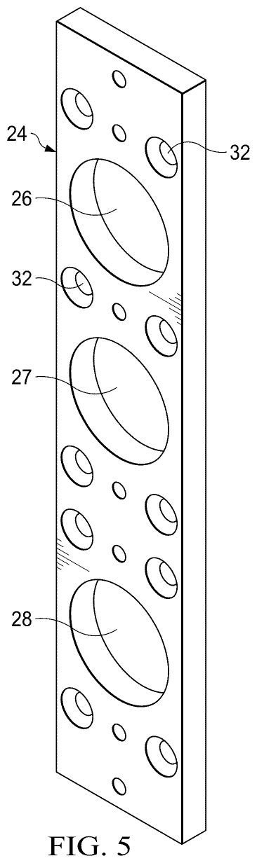

As illustrated in FIG. 5, the lock plate 24 may include a plurality of holes configured to align with the plurality of lock bolt holes 15. In certain embodiments, first hole 26 is configured to align with first lock bolt hole 16, second hole 27 is configured to align with second lock bolt hole 17, and third hole 28 is configured to align with third lock bolt hole 18. The lock plate 24 also includes screw holes 32, which align with screw holes 22 in the door panel 100. The lock plate 24 serves as a lock drill guide and maintains integrity of the door and lock bolt holes 15 during installation and operation of the door panel 100. In certain embodiments, the lock plate 24 is made of steel.

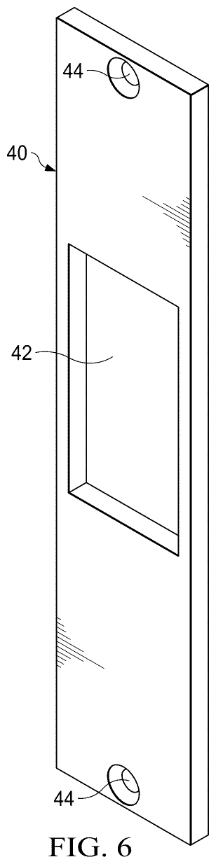

FIG. 6 illustrates an embodiment of a trim plate 40. The trim plate 40 may comprise a rectangular opening 42 designed to expose the lock bolt hole 15 corresponding to an installed lock location and cover the remaining lock bolt holes 15. In the illustrated embodiment, the rectangular opening 42 of the trim plate 40 is configured to expose the second lock bolt hole 17 and cover lock bolt holes 16 and 18 when installed on the door panel 100. In some applications, the illustrated trim plate 40 can be installed when a lock assembly for use with a Curries or Steel Craft door frame lock location is installed in lock bolt hole 17. In certain applications, trim plate 40 can include a hole 42 configured to expose other lock bolt holes 16, 17, or 18, while covering the remaining holes that do not have a lock assembly installed. A trim plate 40 configured to expose lock bolt hole 16 will have a hole 42 at about 41 1/16 inches from the bottom of a door panel. A trim plate 40 configured to expose lock bolt hole 17 will have a hole 42 at about 39 7/16 inches from the bottom of a door panel. A trim plate 40 configured to expose lock bolt hole 16 will have a hole 42 at about 37¼ inches from the bottom of a door panel. The trim plate 40 includes a screw hole 44 at the top and bottom of the trim plate configured to receive a screw so that the trim plate 40 can be attached to the lock plate 24. In certain embodiments, the trim plate 40 is made of steel.

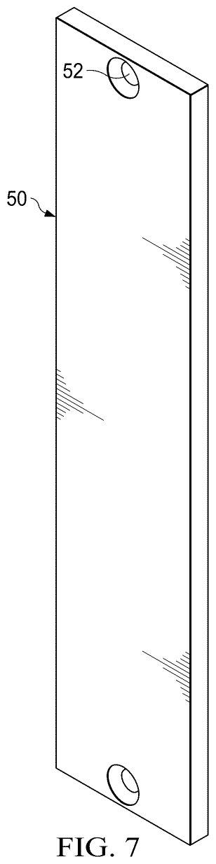

In some embodiments, the door panel 100 can be used within a door frame without installing a lock in a “swing” configuration. Since a lock assembly is not installed in the door panel 100, it may be desired to cover the lock bolt holes 15 to protect the door panel 100 from debris, prevent access to the door panel 100, and minimize pinch points. As illustrated in FIG. 7, the flush trim plate 50 can fully cover the lock plate 24 and the lock bolt holes 15. In those instances, a flush trim plate 50 can be installed on the lock plate 24. The flush trim plate 50 includes a screw hole 52 at the top and bottom of the flush trim plate 50 configured to receive a screw so that the flush trim plate 50 can be attached to the lock plate 24. In certain embodiments, the flush trim plate 50 is made of steel.

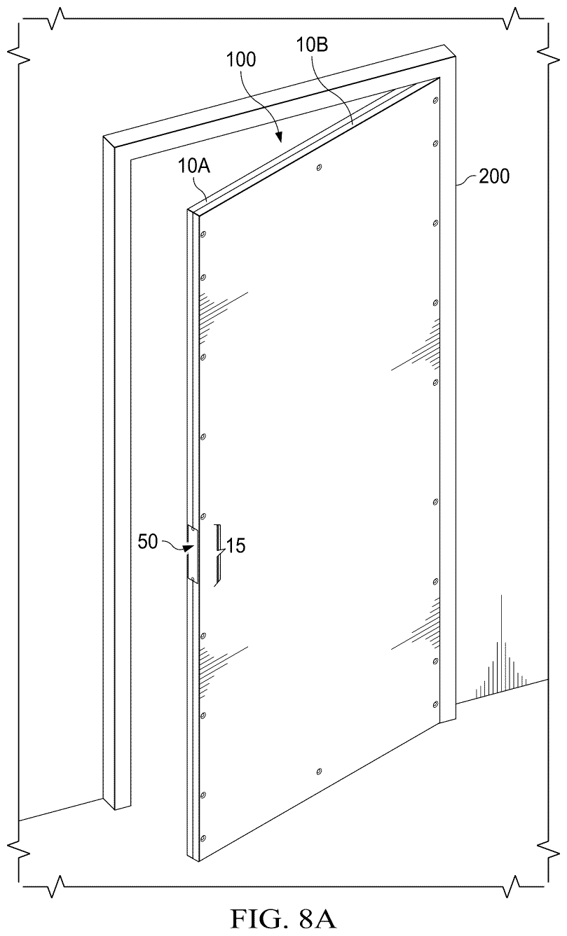

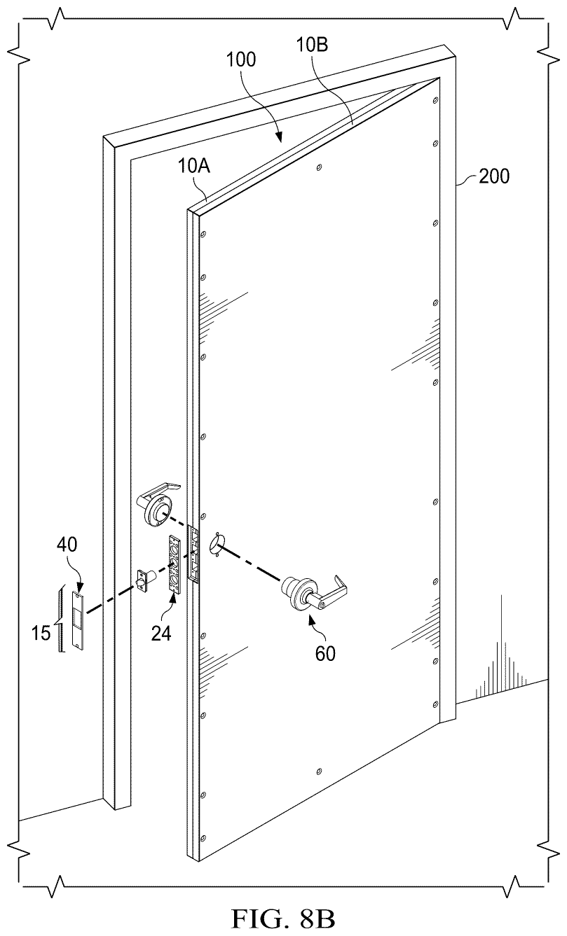

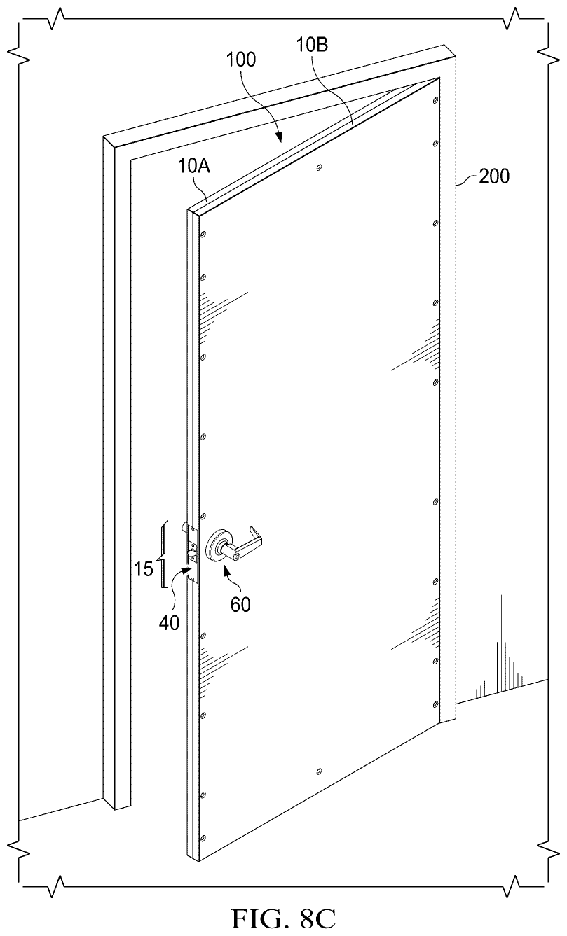

A method of installing a new door without removing the existing door frame is described herein. As illustrated in FIG. 8A, in some embodiments, the door panel 100 is positioned within the existing door frame 200. During this time, it may be advantageous to keep the flush trim plate 50 installed on the lock plate 24. Once the door panel 100 is positioned within the door frame, the installer can remove the flush trim plate 50. As illustrated in FIG. 8B, the installer can then align the lock plate 24 with a strike plate within the door frame 200 and identify the position of the lock assembly corresponding to the desired lock bolt hole 15. Once the lock bolt hole 15 is identified, the installer can then select the corresponding trim plate 40. As illustrated in FIG. 8C, once the correct trim plate 40 is selected and installed, the lock assembly 60 and the door panel 100 can be fully installed within the door frame 200.

It is understood that variations may be made in the foregoing without departing from the scope of the present disclosure. In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, and/or combined, at least in part, with one or more of the other elements and teachings of the various illustrative embodiments.

Any spatial references, such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several exemplary embodiments, while different steps, processes, and procedures are described as appearing as distinct acts, one or more of the steps, one or more of the processes, and/or one or more of the procedures may also be performed in different orders, simultaneously and/or sequentially. In several exemplary embodiments, the steps, processes, and/or procedures may be merged into one or more steps, processes and/or procedures.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112, paragraph 6 for any limitations of any of the claims herein, except for those in which the claim expressly uses the word “means” together with an associated function.

1. A door assembly comprising:
a door panel comprising a plurality of lock bolt holes extending through an edge of the door panel;
a lock plate comprising a plurality of lock plate holes, wherein the lock plate is coupled to the edge of the door panel and each of the plurality of lock plate holes is aligned with a respective lock bolt hole of the plurality of lock bolt holes; and
a removable trim plate coupled to the lock plate and disposed over the plurality of lock plate holes.

2. The door assembly of claim 1, wherein the trim plate comprises a trim plate hole aligned with a first lock bolt hole of the plurality of lock bolt holes.

3. The door assembly of claim 1, wherein the trim plate covers the plurality of lock bolt holes.

4. The door assembly of claim 1, wherein a center of at least one of the plurality of lock bolt holes is disposed about 41 1/16 inches from a bottom edge of the door panel.

5. The door assembly of claim 4, wherein the trim plate comprises a hole exposing the center of the lock bolt hole at about 41 1/16 inches from the bottom edge of the door panel.

6. The door assembly of claim 1, wherein a center of at least one of the plurality of lock bolt holes is disposed about 39 1/16 inches from a bottom edge of the door panel.

7. The door assembly of claim 6, wherein the trim plate comprises a hole exposing the center of the lock bolt hole at about 39 1/16 inches from the bottom edge of the door panel.

8. The door assembly of claim 1, wherein a center of at least one of the plurality of lock bolt holes is disposed about 37¼ inches from a bottom edge of the door panel.

9. The door assembly of claim 8, wherein the trim plate comprises a hole exposing the center of the lock bolt hole at about 37¼ inches from the bottom edge of the door panel.

10. The door assembly of claim 1, wherein the plurality of lock bolt holes are spaced at least 1 inch apart.

11. The door assembly of claim 1, wherein the door panel is 35¾ inches by 83⅛ inches.

12. A polyethylene plastic door assembly comprising:
a polyethylene door comprising:
a first polyethylene plastic door body comprising a first plurality of cut-outs on an inner face of the first polyethylene plastic door body;
a second polyethylene plastic door body comprising a second plurality of cut-outs on an inner face of the second polyethylene plastic door body, wherein the second plurality of cut-outs mirrors the first plurality of cut-outs, and
wherein the inner face of the first polyethylene plastic door body and inner face of the second polyethylene plastic door body are coupled to form the polyethylene door;
a plurality of lock bolt holes extending through an edge of the polyethylene door; and
a lock plate comprising a plurality of lock plate holes, wherein the lock plate is coupled to the edge of the polyethylene door and each of the plurality of lock plate holes is aligned with a respective lock bolt hole of the plurality of lock bolt holes.

13. The polyethylene plastic door assembly of claim 12, further comprising a removable trim plate coupled to the lock plate and disposed over the plurality of lock plate holes.

14. The polyethylene plastic door assembly of claim 12, wherein a center of at least one of the plurality of lock bolt holes is disposed about 41 1/16 inches from a bottom edge of the polyethylene door.

15. The polyethylene plastic door assembly of claim 12, wherein a center of at least one of the plurality of lock bolt holes is disposed about 39 7/16 inches from a bottom edge of the polyethylene door.

16. The polyethylene plastic door assembly of claim 12, wherein a center of at least one of the plurality of lock bolt holes is disposed about 37¼ inches from a bottom edge of the polyethylene door.

17. A method to install a door, the method comprising:
positioning a door panel in a door frame, the door panel comprising a plurality of lock bolt holes extending through an edge of the door panel;
identifying a first lock bolt hole of the plurality of lock bolt holes corresponding to a mating frame bolt hole of the door frame;
installing a trim plate on the door panel to cover the plurality of lock bolt holes other than the first lock bolt hole; and
attaching the door panel to the door frame.

18. The method of claim 17, further comprising installing in the door panel a lock assembly at a location corresponding to the first lock bolt hole.

19. The method of claim 17, further comprising installing in the door panel a lock plate comprising a plurality of lock plate holes, wherein the lock plate is coupled to the edge of the door panel and each of the plurality of lock plate holes is aligned with a respective lock bolt hole of the plurality of lock bolt holes.

20. The method of claim 19, further comprising installing in the door panel a lock assembly at a location corresponding to the first lock bolt hole.
